(19) United States
(12) Patent Application Publication
(10) Pub. No.: US 2026/0245994 A1
(43) Pub. Date: Aug. 20, 2026

(54) LEAK DETECTION IN PRISMATIC BLADE BATTERY CELLS

(71) Applicant: GM Global Technology Operations LLC, Detroit, MI (US)

(72) Inventors: Masoud MohammadPour, Washington, MI (US); Hassan Ghassemi-Armaki, Northville, MI (US); Blair E. Carlson, Ann Arbor, MI (US); Wai Ping Gloria Tam, Troy, MI (US); Randolph Zeitvogel, Beverly Hills, MI (US)

(21) Appl. No.: 19/058,258

(22) Filed: Feb. 20, 2025

(51) Int. Cl. H01M 10/42; G01J 5/08; G01M 3/00; G01M 3/04; G01J 5/00

(52) U.S. Cl. CPC H01M 10/4285; G01J 5/0859; G01M 3/002; G01M 3/04; G01J 2005/0077

(57) ABSTRACT

A system for leak testing a blade battery cell includes a system controller, a slatted conveyor adapted to support and transport blade battery cells to a testing fixture including a first vacuum chamber assembly adapted to selectively engage a first distal end of a blade battery cell, a second vacuum chamber assembly adapted to selectively engage a second distal end of the blade battery cell, and a third vacuum chamber assembly adapted to selectively engage a vent plug of the blade battery cell, wherein, the system is adapted to leak test the blade battery cell by either one of leak testing the blade battery cell with a pressurized trace gas before electrolyte is present within the blade battery cell, or electrolyte leak testing the blade battery cell when electrolyte is present within the blade battery cell.

The present disclosure relates to a method and system for leak testing a prismatic blade battery cell. Current methods for leak testing prismatic battery cells involve placing one or more cells in a vacuum chamber to detect the presence of gas. If a leak is detected in a multi-cell setup, half of the cells in the batch are removed, and the remaining cells are retested. This process requires repeatedly pumping down the vacuum chamber and sensing for gas, continuing iteratively until the leaking cells are identified. However, this approach is not feasible for blade cells due to their larger size, which necessitates a bigger vacuum chamber.

Thus, while current systems and methods of inspecting prismatic blade battery cells achieve their intended purpose, there is a need for a new and improved system and method for individually and sequentially testing prismatic blade battery cells.

### SUMMARY

According to several aspects of the present disclosure, a system for leak testing a prismatic blade battery cell includes a system controller, a slatted conveyor adapted to support and transport blade battery cells to a testing fixture, the testing fixture including a first vacuum chamber assembly adapted to selectively extend, from a retracted position to an extended position and engage a first distal end of a blade battery cell, a second vacuum chamber assembly adapted to selectively extend, from a retracted position to an extended position and engage a second distal end of the blade battery cell, a third vacuum chamber assembly adapted to selectively extend, from a retracted position to an extended position and engage a vent plug of the blade battery cell, wherein, upon engagement of the first vacuum chamber with the first distal end, engagement of the second vacuum chamber with the second distal end and engagement of the third vacuum chamber with the vent plug, the system is adapted to leak test the blade battery cell by either one of leak testing the blade battery cell with a pressurized trace gas before electrolyte is present within the blade battery cell, or electrolyte leak testing the blade battery cell when electrolyte is present within the blade battery cell.

According to another aspect, the first vacuum chamber assembly includes a horizontally moveable left chamber wall and a horizontally moveable right chamber wall, the left chamber wall and the right chamber wall moveable from a retracted position, toward one another, to an engaged position, wherein the left and right chamber walls engage side walls of the blade battery cell at the first distal end and clamp the first distal end therebetween, and a vertically moveable upper chamber wall and a vertically moveable lower chamber wall, the upper chamber wall and the lower chamber wall moveable from a retracted position, toward one another, to an engaged position, wherein the upper and lower chamber walls engage a top surface and a bottom surface of the blade battery cell at the first distal end and clamp the first distal end therebetween, wherein, when the first distal end of the blade battery cell is clamped therein, the left chamber wall, the right chamber wall, the upper chamber wall and the lower chamber wall define a sealed first vacuum chamber that encapsulates the first distal end of the blade battery cell.

According to another aspect, the second vacuum chamber assembly includes a horizontally moveable left chamber wall and a horizontally moveable right chamber wall, the left chamber wall and the right chamber wall moveable from a retracted position, toward one another, to an engaged position, wherein the left and right chamber walls engage the side walls of the blade battery cell at the second distal end and clamp the second distal end therebetween, and a vertically moveable upper chamber wall and a vertically moveable lower chamber wall, the upper chamber wall and the lower chamber wall moveable from a retracted position, toward one another, to an engaged position, wherein the upper and lower chamber walls engage the top surface and the bottom surface of the blade battery cell at the second distal end and clamp the second distal end therebetween, wherein, when the second distal end of the blade battery cell is clamped therein, the left chamber wall, the right chamber wall, the upper chamber wall and the lower chamber wall define a sealed second vacuum chamber that encapsulates the second distal end of the blade battery cell.

According to another aspect, the third vacuum chamber assembly includes a horizontally moveable rear chamber wall and a horizontally moveable front chamber wall, the rear chamber wall and the front chamber wall moveable from a retracted position, toward one another, to an engaged position, wherein the rear and front chamber walls engage the side walls of the blade battery cell between the first and second distal ends and clamp the blade battery cell therebetween, wherein, when the blade battery cell is clamped therein, the rear chamber wall supports the blade battery cell and the front chamber wall defines a sealed third vacuum chamber that encapsulates the vent plug of the blade battery cell.

According to another aspect, the first distal end of the blade battery cell includes an electrolyte fill port adapted to allow electrolyte to be fed into the blade battery cell and the first vacuum chamber assembly includes an electrolyte nozzle in communication with a trace gas supply module and adapted to engage the electrolyte fill port when the first vacuum chamber assembly engages the first distal end of the blade battery cell, wherein, when leak testing the blade battery cell with a pressurized trace gas before electrolyte is present within the blade battery cell, the system controller is adapted to actuate the trace gas supply module and feed the pressurized trace gas from the trace gas supply module, through the electrolyte port, into the blade battery cell.

According to another aspect, the first, second and third vacuum chambers are in communication with a common vacuum pump adapted to generate a vacuum drawing gas from each of the first, second and third vacuum chambers, a first test chamber is positioned between the first vacuum chamber and the vacuum pump, wherein gas drawn from the first vacuum chamber passes through the first test chamber, a second test chamber is positioned between the second vacuum chamber and the vacuum pump, wherein gas drawn from the second vacuum chamber passes through the second test chamber, a third test chamber is positioned between the third vacuum chamber and the vacuum pump, wherein gas drawn from the third vacuum chamber passes through the third test chamber, wherein, when electrolyte leak testing the blade battery cell when electrolyte is present within the blade battery cell, the system is adapted to individually monitor gases passing through each one of the first, second and third test chambers to identify electrolyte leakage from the first distal end, the second distal end and the vent plug of the blade battery cell.

According to another aspect, the system further includes a radiation source positioned behind the first, second and third test chambers adapted to irradiate the first, second and third test chambers and gases passing through the first, second and third testing chambers, an infrared camera positioned in front of the first, second and third testing chambers, wherein the first test chamber, the second test chamber and the third test chamber each includes a window that is within a field of view of the infrared camera.

According to another aspect, the radiation source is adapted to produce radiation ranging from about two micrometers to about ten micrometers.

According to another aspect, each of the windows of the first, second and third test chambers is made from sodium chloride glass that is adapted to transmit radiation ranging from about two-hundred-fifty nanometers to about sixteen micrometers.

According to another aspect, for monitoring leakage of carbon dioxide trace gas, the infrared camera includes a filter having a bandpass of about four and one-tenth microns to about four and eight-tenths microns, and for monitoring electrolyte leakage, the infrared camera includes a filter having a bandpass of about seven micrometers to about eight and one-half micrometers.

According to another aspect, the slatted conveyor includes a plurality of slats, each slat adapted to hold and transport a blade battery cell, each blade battery cell including a 2D matrix including information for the blade battery cell, wherein, the system controller is adapted to read, using a camera in communication with the system controller, the 2D matrix, and write the information from the 2D matrix onto a radio frequency identification tag on the slat, advance, with the conveyor, the blade battery cell to the testing fixture, move the first, second and third vacuum chamber assemblies from the retracted position to the engaged position, move the left chamber wall and the right chamber wall of each of the first and second vacuum chamber assemblies from the retracted position to the engaged position, move the upper chamber wall and the lower chamber wall of each of the first and second vacuum chamber assemblies from the retracted position to the engaged position, move the rear chamber wall and the front chamber wall of the third vacuum chamber assembly to the engaged position, leak test the blade battery cell, write the leak testing results to the radio frequency identification tag on the slat, move the left chamber wall and the right chamber wall of each of the first and second vacuum chamber assemblies from the engaged position to the retracted position, move the upper chamber wall and the lower chamber wall of each of the first and second vacuum chamber assemblies from the engaged position to the retracted position, move the rear chamber wall and the front chamber wall of the third vacuum chamber assembly from the engaged position to the retracted position, move the first, second and third vacuum chamber assemblies from the engaged position to the retracted position, and advance the slatted conveyor.

According to several aspects of the present disclosure, a method for leak testing a prismatic blade battery cell, comprising, with a system having a system controller, supporting and transporting a blade battery cell to a testing fixture of the system, extending a first vacuum chamber assembly from a retracted position to an extended position, engaging, with the first vacuum chamber assembly, a first distal end of the blade battery cell, extending a second vacuum chamber assembly from a retracted position to an extended position, engaging, with the second vacuum chamber assembly, a second distal end of the blade battery cell, extending a third vacuum chamber assembly from a retracted position to an extended position, engaging, with the third vacuum chamber assembly, a vent plug of the blade battery cell, and leak testing the blade battery cell by either one of leak testing the blade battery cell with a pressurized trace gas before electrolyte is present within the blade battery cell, or electrolyte leak testing the blade battery cell when electrolyte is present within the blade battery cell.

According to another aspect, the engaging, with the first vacuum chamber assembly, a first distal end of the blade battery cell further includes moving, with the system controller, a horizontally moveable left chamber wall and a horizontally moveable right chamber wall of the first vacuum chamber assembly from a retracted position, toward one another, to an engaged position, wherein the left and right chamber walls engage side walls of the blade battery cell at the first distal end and clamp the first distal end therebetween, and moving, with the system controller, a vertically moveable upper chamber wall and a vertically moveable lower chamber wall of the first vacuum chamber assembly from a retracted position, toward one another, to an engaged position, wherein the upper and lower chamber walls engage a top surface and a bottom surface of the blade battery cell at the first distal end and clamp the first distal end therebetween, and defining, with the left chamber wall, the right chamber wall, the upper chamber wall and the lower chamber wall of the first vacuum chamber assembly, a sealed first vacuum chamber that encapsulates the first distal end of the blade battery cell.

According to another aspect, the engaging, with the second vacuum chamber assembly, a second distal end of the blade battery cell further includes moving, with the system controller, a horizontally moveable left chamber wall and a horizontally moveable right chamber wall of the second vacuum chamber assembly from a retracted position, toward one another, to an engaged position, wherein the left and right chamber walls engage side walls of the blade battery cell at the second distal end and clamp the second distal end therebetween, and moving, with the system controller, a vertically moveable upper chamber wall and a vertically moveable lower chamber wall of the second vacuum chamber assembly from a retracted position, toward one another, to an engaged position, wherein the upper and lower chamber walls engage a top surface and a bottom surface of the blade battery cell at the second distal end and clamp the second distal end therebetween, and defining, with the left chamber wall, the right chamber wall, the upper chamber wall and the lower chamber wall of the second vacuum chamber assembly, a sealed second vacuum chamber that encapsulates the second distal end of the blade battery cell.

According to another aspect, the engaging, with the third vacuum chamber assembly, a vent plug of the blade battery cell further includes moving, with the system controller, a horizontally moveable rear chamber wall and a horizontally moveable front chamber wall of the third vacuum chamber assembly from a retracted position, toward one another, to an engaged position, wherein the rear and front chamber walls engage the side walls of the blade battery cell between the first and second distal ends and clamp the blade battery cell therebetween, supporting the blade battery cell with the rear chamber wall of the third vacuum chamber assembly, and defining, with the front chamber wall of the third vacuum chamber assembly, a sealed third vacuum chamber that encapsulates the vent plug of the blade battery cell.

According to another aspect, the engaging, with the first vacuum chamber assembly, a first distal end of the blade battery cell further includes engaging, with an electrolyte nozzle in communication with a trace gas supply module, an electrolyte fill port formed within the first distal end of the blade battery cell and adapted to allow electrolyte to be fed into the blade battery cell, and the leak testing the blade battery cell with a pressurized trace gas before electrolyte is present within the blade battery cell further includes actuating, with the system controller, the trace gas supply module and feeding the pressurized trace gas from the trace gas supply module, through the electrolyte port, into the blade battery cell.

According to another aspect, the electrolyte leak testing the blade battery cell when electrolyte is present within the blade battery cell further includes individually monitoring gases passing through each one of a first test chamber that is positioned between the first vacuum chamber and a vacuum pump in communication with the first, second and third vacuum chambers and adapted to draw gas from each one of the first, second and third vacuum chambers, a second test chamber that is positioned between the second vacuum chamber and the vacuum pump, wherein gas drawn from the second vacuum chamber passes through the second test chamber, and a third test chamber that is positioned between the third vacuum chamber and the vacuum pump, wherein gas drawn from the third vacuum chamber passes through the third test chamber, and identifying electrolyte leakage from the first distal end, the second distal end and the vent plug of the blade battery cell.

According to another aspect, the individually monitoring gases passing through each one of the first test chamber, the second test chamber and the third test chamber further includes applying radiation to the first, second and third test chambers and gases passing through the first, second and third test chambers, with a radiation source adapted to produce radiation ranging from about two micrometers to about ten micrometers and positioned behind the first, second and third test chambers, and capturing images with an infrared camera positioned in front of the first, second and third testing chambers, wherein the first test chamber, the second test chamber and the third test chamber each includes a window that is within a field of view of the infrared camera and is made from sodium chloride glass that is adapted to transmit radiation ranging from about two-hundred-fifty nanometers to about sixteen micrometers.

According to another aspect, the method further includes supporting and transporting, with a plurality of slats of the slatted conveyor, a plurality of blade battery cells, one blade battery cell positioned on each one of the plurality of slats, and with the system controller, prior to leak testing a blade battery cell, reading, using a camera in communication with the system controller, a 2D matrix attached to a blade battery cell, writing the information from the 2D matrix onto a radio frequency identification tag on a one of the plurality of slats that is carrying the blade battery cell, advancing, with the slatted conveyor, the blade battery cell to the testing fixture, and, with the system controller, after leak testing the blade battery cell, writing the leak testing results to the radio frequency identification tag on the slat, moving the left chamber wall and the right chamber wall of each of the first and second vacuum chamber assemblies from the engaged position to the retracted position, moving the upper chamber wall and the lower chamber wall of each of the first and second vacuum chamber assemblies from the engaged position to the retracted position, moving the rear chamber wall and the front chamber wall of the third vacuum chamber assembly from the engaged position to the retracted position, moving the first, second and third vacuum chamber assemblies from the engaged position to the retracted position, and advancing the slatted conveyor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic perspective view of a system for leak testing blade battery cells in accordance with an exemplary embodiment of the present disclosure;

FIG. 2 is a schematic diagram of the system shown in FIG. 1;

FIG. 3A is an enlarged view of a portion of FIG. 1, as indicated by the circled area labeled “FIG. 3A” in FIG. 1;

FIG. 3B is a partial sectional view of a first vacuum chamber formed by the first vacuum chamber assembly;

FIG. 4A is an enlarged view of a portion of FIG. 1, as indicated by the circled area labeled “FIG. 4A” in FIG. 1;

FIG. 4B is a partial sectional view of a second vacuum chamber formed by the second vacuum chamber assembly;

FIG. 5A is an enlarged view of a portion of FIG. 1, as indicated by the circled area labeled “FIG. 5A” in FIG. 1;

FIG. 5B is a partial sectional view of a third vacuum chamber formed by the third vacuum chamber assembly;

FIG. 6A is a perspective view of the first vacuum chamber assembly where an upper chamber wall has been removed to illustrate the electrolyte nozzle of the first vacuum chamber assembly;

FIG. 6B is a perspective view of the first distal end of the blade battery cell;

FIG. 7 is an enlarged view of a portion of FIG. 1, as indicated by the circled area labeled “FIG. 7” in FIG. 1;

FIG. 8 is an enlarged view of a portion of FIG. 1, as indicated by the circled area labeled “FIG. 8” in FIG. 1; and

FIG. 9 is a flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

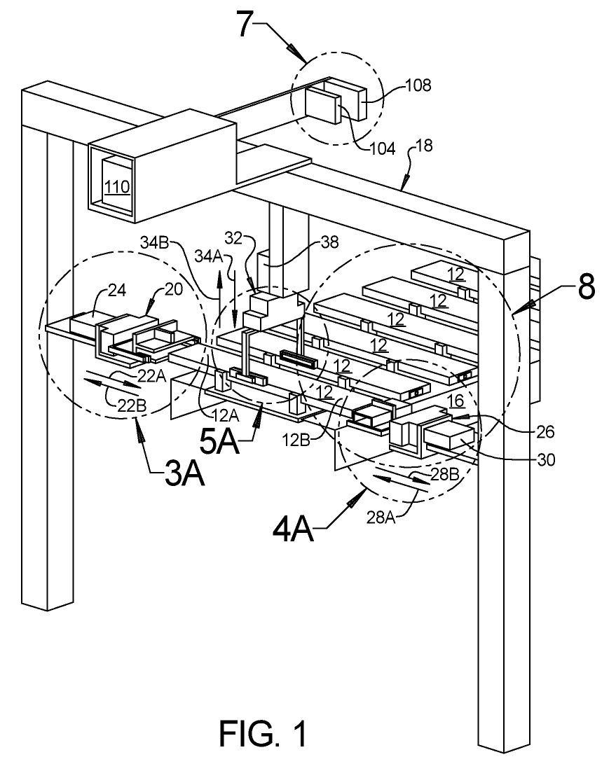

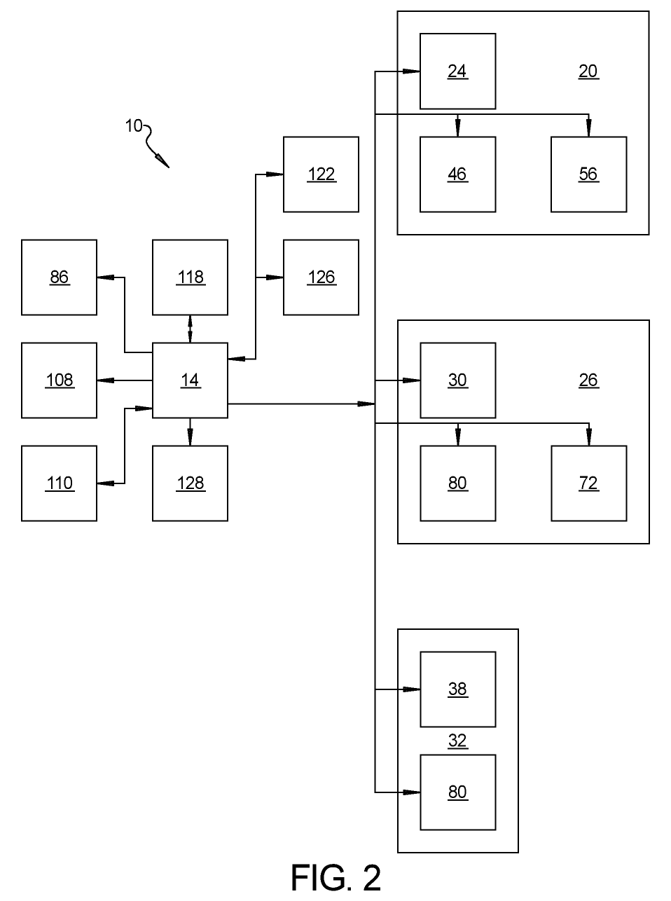

Example embodiments will now be described more fully with reference to the accompanying drawings. In accordance with an exemplary embodiment, FIG. 1 shows a system 10 for leak testing a prismatic blade battery cell 12. Referring to FIG. 2, the system 10 includes a system controller 14 adapted to operate the system.

The system controller 14 is non-generalized, electronic control device having at least one processor and a computer readable storage device or media. The at least one data processor can be any custom made or commercially available processor, a central processing unit (CPU), a graphics processing unit (GPU), an auxiliary processor among several processors associated with the system controller 16, a semi-conductor based microprocessor (in the form of a microchip or chip set), a macro-processor, any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the at least one data processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the system controller 14 in controlling the system 10.

Although only one system controller 14 is shown in FIG. 2, embodiments of the system 10 can include any number of controllers that communicate over any suitable communication medium or a combination of communication mediums and that cooperate to process sensor signals, perform logic, calculations, methods, and/or algorithms, and generate control signals to automatically control features of the system 10.

Referring again to FIG. 1, the system 10 includes a slatted conveyor 16 adapted to support and transport blade battery cells 12 to a testing fixture 18. The testing fixture 18 includes a first vacuum chamber assembly 20 adapted to selectively extend, back and forth, from a retracted position to an extended position, as indicated by arrow 22A, and from the extended position to the retracted position, as indicated by arrow 22B. When the first vacuum chamber assembly 20 extends from the retracted position to the extended position, the first vacuum chamber assembly 20 is adapted to engage a first distal end 12A of a blade battery cell 12 that is positioned within the test fixture 18. The first vacuum chamber assembly 20 is moved between the extended and retracted positions by a first actuator 24 that is in communication with the system controller 14 and is adapted to, upon direction from the system controller 14, selectively move the first vacuum chamber assembly 20 either, from the retracted position to the extended position, or from the extended position to the retracted position.

The testing fixture 18 includes a second vacuum chamber assembly 26 adapted to selectively extend, back and forth, from a retracted position to an extended position, as indicated by arrow 28A, and from the extended position to the retracted position, as indicated by arrow 28B. When the second vacuum chamber assembly 26 extends from the retracted position to the extended position, the second vacuum chamber assembly 26 is adapted to engage a second distal end 12B of the blade battery cell 12 that is positioned within the test fixture 18. The second vacuum chamber assembly 26 is moved between the extended and retracted positions by a second actuator 30 that is in communication with the system controller 14 and is adapted to, upon direction from the system controller 14, selectively move the second vacuum chamber assembly 26 either, from the retracted position to the extended position, or from the extended position to the retracted position.

The testing fixture 18 includes a third vacuum chamber assembly 32 adapted to selectively extend, back and forth, from a retracted position to an extended position, as indicated by arrow 34A, and from the extended position to the retracted position, as indicated by arrow 34B. When the third vacuum chamber assembly 32 extends from the retracted position to the extended position, the third vacuum chamber assembly 32 is adapted to engage a vent plug 36 of the blade battery cell 12 that is positioned between the first and second distal ends 12A, 12B of the blade battery cell 12. The third vacuum chamber assembly 32 is moved between the extended and retracted positions by a third actuator 38 that is in communication with the system controller 14 and is adapted to, upon direction from the system controller 14, selectively move the third vacuum chamber assembly 32 either, from the retracted position to the extended position, or from the extended position to the retracted position.

Upon engagement of the first vacuum chamber 20 with the first distal end 12A, engagement of the second vacuum chamber 26 with the second distal end 12B and engagement of the third vacuum chamber 32 with the vent plug 36, the system 10 is adapted to leak test the blade battery cell 12 by either one of 1) leak testing the blade battery cell 12 with a pressurized trace gas, such as carbon dioxide, before electrolyte is present within the blade battery cell 12, or 2) electrolyte leak testing the blade battery cell 12 when electrolyte is present within the blade battery cell 12.

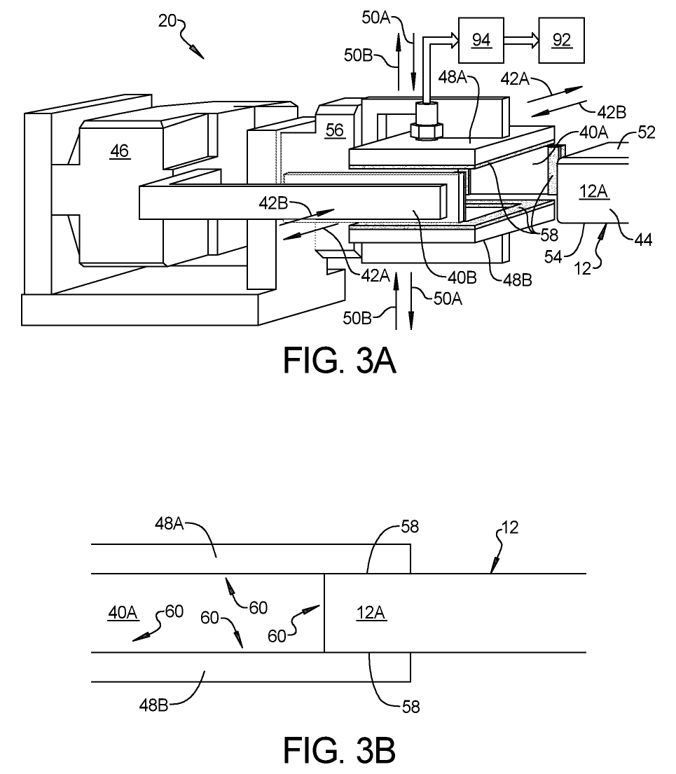

Referring to FIG. 3A, in an exemplary embodiment the first vacuum chamber assembly 20 includes a horizontally moveable left chamber wall 40A and a horizontally moveable right chamber wall 40B, the left chamber wall 40A and the right chamber wall 40B moveable from a retracted position, toward one another, as shown by arrows 42A, to an engaged position, and from the engaged position, away from one another, as shown by arrows 42B, to the retracted position. When the left chamber wall 40A and the right chamber wall 40B move to the engaged position, the left chamber wall 40A and the right chamber wall 40B engage side walls 44 of the blade battery cell 12 at the first distal end 12A and clamp the first distal end 12A therebetween.

The left chamber wall 40A and the right chamber wall 40B are simultaneously moved between the extended and retracted positions by a fourth actuator 46 that is in communication with the system controller 14 and is adapted to, upon direction from the system controller 14, selectively move the left and right chamber walls 40A, 40B of the first vacuum chamber assembly 20 either, from the retracted position to the extended position, or from the extended position to the retracted position.

The first vacuum chamber assembly 20 further includes a vertically moveable upper chamber wall 48A and a vertically moveable lower chamber wall 48B, the upper chamber wall 48A and the lower chamber wall 48B moveable from a retracted position, toward one another, as shown by arrows 50A, to an engaged position, and from the engaged position, away from one another, as shown by arrows 50B, to the retracted position. When the upper chamber wall 48A and the lower chamber wall 48B move to the engaged position, the upper chamber wall 48A and the lower chamber wall 48B engage a top surface 52 and a bottom surface 54 of the blade battery cell 12 at the first distal end 12A and clamp the first distal end 12A therebetween.

The upper chamber wall 48A and the lower chamber wall 48B are simultaneously moved between the extended and retracted positions by a fifth actuator 56 that is in communication with the system controller 14 and is adapted to, upon direction from the system controller 14, selectively move the upper and lower chamber walls 48A, 48B of the first vacuum chamber assembly 20 either, from the retracted position to the extended position, or from the extended position to the retracted position.

Each of the left chamber wall 40A, the right chamber wall 40B, the upper chamber wall 48A and the lower chamber wall 48B of the first vacuum chamber assembly 20 includes a sealing material 58, such as soft foam or rubber, extending around edges thereof. Referring to FIG. 3B, when the first distal end 12A of the blade battery cell 12 is clamped therein, the left chamber wall 40A, the right chamber wall 40B (not shown in sectional view of FIG. 3B), the upper chamber wall 48A and the lower chamber wall 48B define a sealed first vacuum chamber 60 that encapsulates the first distal end 12A of the blade battery cell 12.

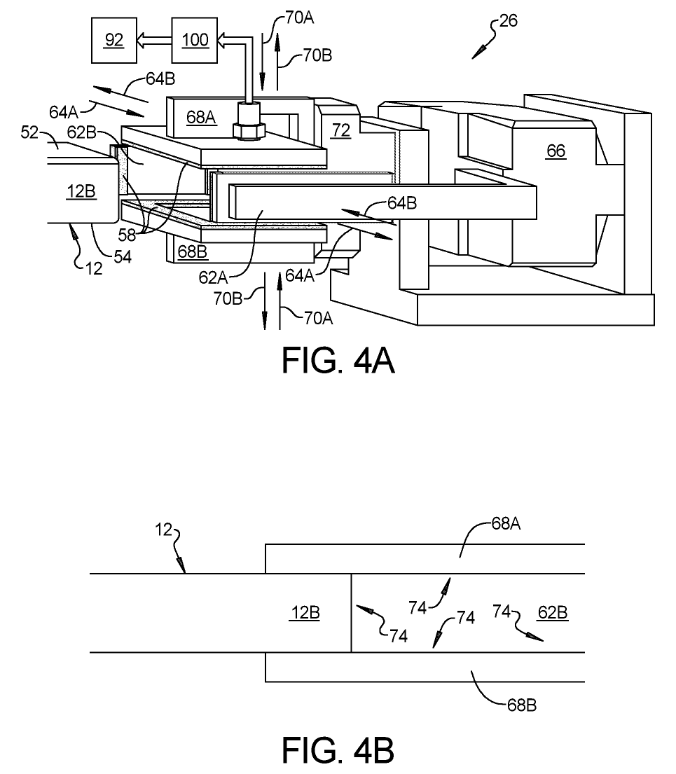

Referring to FIG. 4A, in an exemplary embodiment the second vacuum chamber assembly 26 includes a horizontally moveable left chamber wall 62A and a horizontally moveable right chamber wall 62B, the left chamber wall 62A and the right chamber wall 62B moveable from a retracted position, toward one another, as shown by arrows 64A, to an engaged position, and from the engaged position, away from one another, as shown by arrows 64B, to the retracted position. When the left chamber wall 62A and the right chamber wall 62B move to the engaged position, the left chamber wall 62A and the right chamber wall 62B engage side walls 44 of the blade battery cell 12 at the second distal end 12B and clamp the second distal end 12B therebetween.

The left chamber wall 62A and the right chamber wall 62B are simultaneously moved between the extended and retracted positions by a sixth actuator 66 that is in communication with the system controller 14 and is adapted to, upon direction from the system controller 14, selectively move the left and right chamber walls 62A, 62B of the second vacuum chamber assembly 26 either, from the retracted position to the extended position, or from the extended position to the retracted position.

The second vacuum chamber assembly 26 further includes a vertically moveable upper chamber wall 68A and a vertically moveable lower chamber wall 68B, the upper chamber wall 68A and the lower chamber wall 68B moveable from a retracted position, toward one another, as shown by arrows 70A, to an engaged position, and from the engaged position, away from one another, as shown by arrows 70B, to the retracted position. When the upper chamber wall 68A and the lower chamber wall 68B move to the engaged position, the upper chamber wall 68A and the lower chamber wall 68B engage the top surface 52 and the bottom surface 54 of the blade battery cell 12 at the second distal end 12B and clamp the second distal end 12B therebetween.

The upper chamber wall 68A and the lower chamber wall 68B are simultaneously moved between the extended and retracted positions by a seventh actuator 72 that is in communication with the system controller 14 and is adapted to, upon direction from the system controller 14, selectively move the upper and lower chamber walls 68A, 68B of the second vacuum chamber assembly 26 either, from the retracted position to the extended position, or from the extended position to the retracted position.

Each of the left chamber wall 62A, the right chamber wall 62B, the upper chamber wall 68A and the lower chamber wall 68B of the second vacuum chamber assembly 26 includes a sealing material 58, such as soft foam or rubber, extending around edges thereof. Referring to FIG. 4B, when the second distal end 12B of the blade battery cell 12 is clamped therein, the left chamber wall 62A (not shown in sectional view of FIG. 4B), the right chamber wall 62B, the upper chamber wall 68A and the lower chamber wall 68B define a sealed second vacuum chamber 74 that encapsulates the second distal end 12B of the blade battery cell 12.

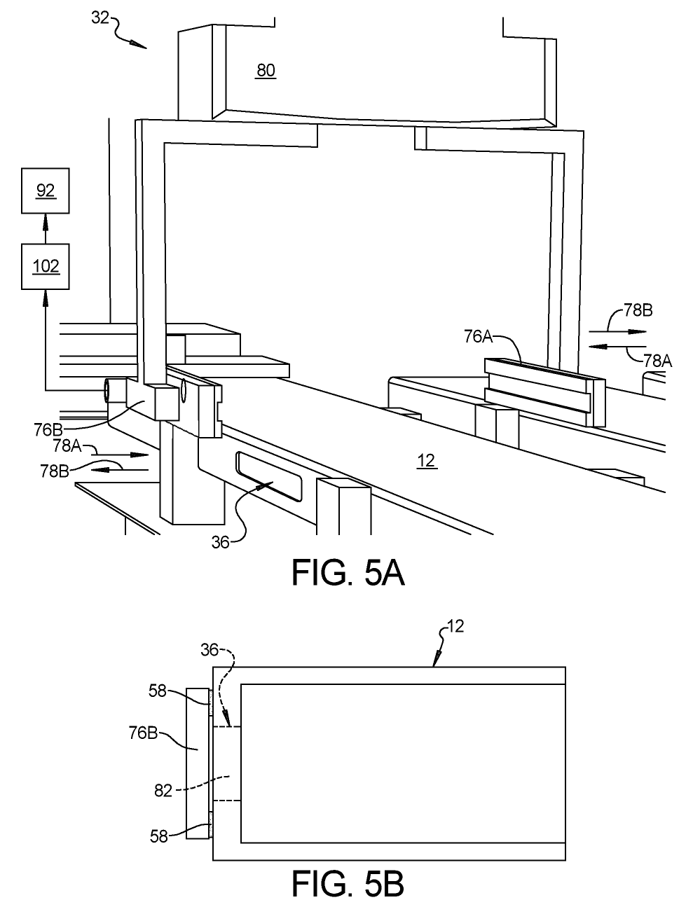

Referring to FIG. 5A, the third vacuum chamber assembly 32 includes a horizontally moveable rear chamber wall 76A and a horizontally moveable front chamber wall 76B, the rear chamber wall 76A and the front chamber wall 76B moveable from a retracted position, toward one another, as shown by arrows 78A to an engaged position, and from the engaged position, away from one another, as shown by arrows 78B, to the retracted position.

The rear and front chamber walls 76A, 76B engage the side walls 44 of the blade battery cell 12 between the first and second distal ends 12A, 12B and clamp the blade battery cell 12 therebetween. The rear chamber wall 76A and the front chamber wall 76B are simultaneously moved between the extended and retracted positions by an eighth actuator 88 that is in communication with the system controller 14 and is adapted to, upon direction from the system controller 14, selectively move the rear and front chamber walls 76A, 76B of the third vacuum chamber assembly 32 either, from the retracted position to the extended position, or from the extended position to the retracted position.

The front chamber wall 76B includes a sealing material 58, such as soft foam or rubber, extending around edges thereof. When the blade battery cell 12 is clamped therein, the rear chamber wall 76A supports the blade battery cell 12 and, referring to FIG. 5B, the front chamber wall 76B defines a sealed third vacuum chamber 82 that encapsulates the vent plug 36 of the blade battery cell 12.

The first actuator 24, the second actuator 30, the third actuator 38, the fourth actuator 46, the fifth actuator 56, the sixth actuator 66, the seventh actuator 72 and the eighth actuator 80 can each be any type of known actuator, such as, a motor/gear arrangement, or a hydraulic, pneumatic or linear actuator or solenoid depending on application needs. In an exemplary embodiment, the left and right chamber walls 40A, 40B of the first vacuum chamber assembly are interconnected by a geared arrangement, wherein movement of one of the left and right chamber walls 40A, 40B of the first vacuum chamber causes corresponding movement of the other one of the left and right chamber walls 40A, 40B of the first vacuum chamber, wherein the fourth actuator is adapted to act on the geared arrangement interconnecting the left and right chamber walls 40A, 40B to simultaneously move each of the left and right chamber walls 40A, 40B in unison. It should be understood that is various embodiments, the upper and lower chamber walls 48A, 48B of the first vacuum chamber assembly 20, the left and right chamber walls 62A, 62B and the upper and lower chamber walls 68A, 68B of the second vacuum chamber assembly 26 and the rear and front chamber walls 76A, 76B of the third vacuum chamber assembly 32 may be interconnected similarly.

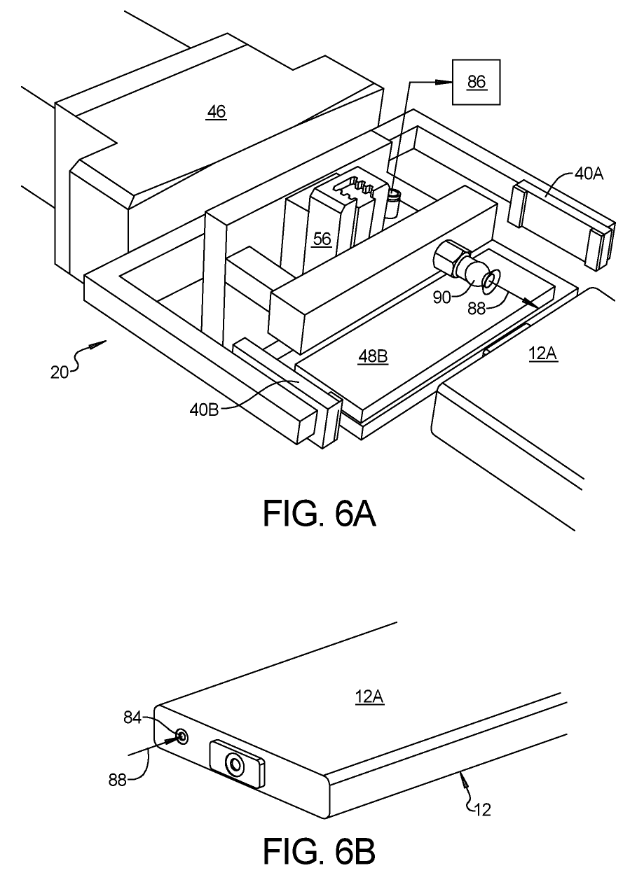

Referring to FIG. 6A and FIG. 6B, in another exemplary embodiment, the first distal end 12A of the blade battery cell 12 includes an electrolyte fill port 84 adapted to allow electrolyte to be fed into the blade battery cell 12 and the first vacuum chamber 60 assembly includes an electrolyte nozzle 90 in communication with a trace gas supply module 86 and adapted to engage the electrolyte fill port 84 when the first vacuum chamber assembly 20 engages the first distal end 12A of the blade battery cell 12. As shown, the upper chamber wall 48A of the first vacuum chamber assembly 20 is removed to show that the electrolyte nozzle 86 is supported on structure of the first vacuum chamber assembly 20 and extends outward and is received within the electrolyte fill port 84 of the first distal end 12A of the blade battery cell 12 when the first vacuum chamber assembly 20 engages the first distal end 12A of the blade battery cell 12.

When the system 10 leak tests the blade battery cell 12 with a pressurized trace gas, such as carbon dioxide, before electrolyte is present within the blade battery cell 12, the system controller 14 is adapted to actuate the trace gas supply module 86 and feed the pressurized trace gas from the trace gas supply module 86, through the electrolyte fill port 84, into the blade battery cell 12, as indicated by arrow 88. Once the pressurized gas is fed into the blade battery cell 12, the blade battery cell 12 is pressure leak tested by known methods.

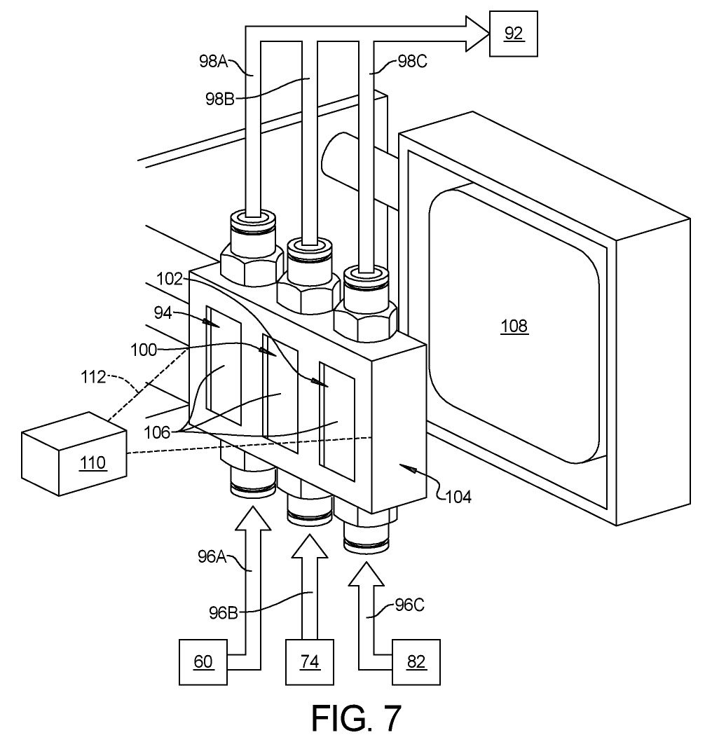

Referring to FIG. 7, the first, second and third vacuum chambers 60, 74, 82 are in communication with a common vacuum pump 92 adapted to generate a vacuum, drawing gas from each of the first, second and third vacuum chambers 60, 74, 82. A first test chamber 94 is positioned between the first vacuum chamber 60 and the vacuum pump 92, wherein gas drawn from the first vacuum chamber 60 passes through the first test chamber 94, as indicated by arrow 96A, and on to the vacuum pump 92, as indicated by arrow 98A. A second test chamber 100 is positioned between the second vacuum chamber 74 and the vacuum pump 92, wherein gas drawn from the second vacuum chamber 74 passes through the second test chamber 100, as indicated by arrow 96B, and on to the vacuum pump 92, as indicated by arrow 98B. A third test chamber 102 is positioned between the third vacuum chamber 82 and the vacuum pump 92, wherein gas drawn from the third vacuum chamber 82 passes through the third test chamber 102, as indicated by arrow 96C, and on to the vacuum pump 92, as indicated by arrow 98C.

As shown, the first, second and third test chambers 94, 100, 102 are defined within a common housing 104. Each of the first test chamber 94, the second test chamber 100 and the third test chamber 102 includes a window 106 made from sodium chloride glass and adapted to transmit radiation ranging from about two-hundred-fifty nanometers to about sixteen micrometers. A radiation source 108 is positioned behind the first, second and third test chambers 94, 100, 102 and is adapted to irradiate the first, second and third test chambers 94, 100, 102 and gases passing through the first, second and third testing chambers 94, 100, 102 with radiation ranging from about two micrometers to about ten micrometers. An infrared camera 110 having a filter with a bandpass of about seven micrometers to about eight and one-half micrometers is positioned in front of the first, second and third testing chambers 94, 100, 102, wherein the windows 106 formed within each of the first, second and third test chambers 94, 100, 102 is within a field of view 112 of the infrared camera 110.

When electrolyte leak testing the blade battery cell 12 when electrolyte is present within the blade battery cell 12, the system 10 is adapted to individually monitor, with the infrared camera 110, gases passing through each one of the first, second and third test chambers 94, 100, 102 to identify electrolyte leakage from the first distal end 12A, the second distal end 12B and the vent plug 36 of the blade battery cell 12. The system controller 16 uses data from the infrared camera 110 and associated algorithms to determine the presence of electrolyte within the gas passing through each of the first, second and third testing chambers 94, 100, 102 using methods known in the industry.

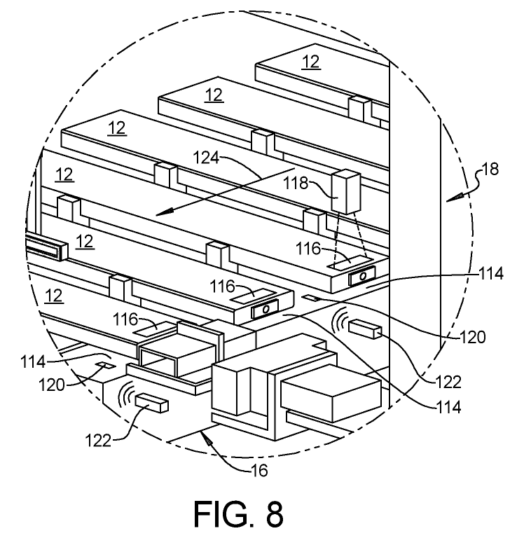

Referring to FIG. 8, the slatted conveyor 16 includes a plurality of slats 114, each slat 114 adapted to hold and transport a blade battery cell 12, each blade battery cell 12 including a 2D matrix 116 including information for the blade battery cell 12. The advantage of the system 10 of the present disclosure is that blade battery cells 12 can be leak tested in an automatic, sequential manner, allowing faster, assembly-line style leak testing, improving cycle times and efficiency.

The system controller 14 is adapted to read, using a camera 118 in communication with the system controller 14, the 2D matrix 116, and write the information from the 2D matrix 116, onto a radio frequency identification (RFID) tag 120 on the slat 114 before the slat 114 reaches the testing fixture 18. The system uses an RFID reader 122 to encode the data from the 2D matrix onto the RFID tag 120. Then, the system controller 14 advances, with the conveyor 16, by actuating a conveyor motor module 128, the blade battery cell 12 to the testing fixture 18, as shown by arrow 124. Once the blade battery cell 12 is within the testing fixture 18, the system controller 14 actuates the first, second and third actuators 24, 30, 38 to move each of the first, second and third vacuum chamber assemblies 20, 26, 32 from the retracted position to the engaged position. The system controller 14 then actuates the fourth actuator 46, the fifth actuator 56, the sixth actuator 66, and the seventh actuator 72 and moves the left chamber wall 40A, 62A and the right chamber wall 40B, 62B of each of the first and second vacuum chamber assemblies 20, 26 from the retracted position to the engaged position, and moves the upper chamber wall 48A, 68A and the lower chamber wall 48B, 68B of each of the first and second vacuum chamber assemblies 20, 26 from the retracted position to the engaged position. The system controller 14 then actuates eighth actuator 80 and moves the rear chamber wall 76A and the front chamber wall 76B of the third vacuum chamber assembly 32 to the engaged position, and leaks tests the blade battery cell 12.

Once the blade battery cell 12 has been leak tested, the system controller 14 is further adapted to write, with the RFID reader 122, the leak testing results to the radio frequency identification tag 120 on the slat 114. When the conveyor 16 advances the slat 114 with the blade battery cell 12 into position, the RFID reader 122 reads the contents of the RFID tag 120 on the slat 114. This information may or may not contain a Part Unique Number that was acquired by the camera 118 from the 2D matrix 116. The blade battery cell 12 is leak tested, and once the leak test has been completed, the system controller 14, via the RFID reader 122, writes the results, pass or fail, back to the RFID tag 120 on the slat 114 before the slat 114 and the blade battery cell 12 are advanced to the next station. The system controller 14 then releases the blade battery cell 12 from the testing fixture 18 by actuating the fourth actuator 46, the fifth actuator 56, the sixth actuator 66, and the seventh actuator 72 to move the left chamber wall 40A, 62A and the right chamber wall 40B, 62B of each of the first and second vacuum chamber assemblies 20, 26 from the engaged position to the retracted position, and move the upper chamber wall 48A, 68A and the lower chamber wall 48B, 68B of each of the first and second vacuum chamber assemblies 20, 26 from the engaged position to the retracted position. The system controller 14 then actuates the eighth actuator 80 and moves the rear chamber wall 76A and the front chamber wall 76B of the third vacuum chamber assembly 32 to the retracted position. Finally, the system controller 14 actuates the first, second and third actuators 24, 30, 38 to move each of the first, second and third vacuum chamber assemblies 20, 26, 32 from the engaged position to the retracted position. Once the first, second and third vacuum chamber assemblies are fully retracted, the system controller advances the conveyor 16 as indicated by 124, and moves the tested blade battery cell 12 from the testing fixture 18 and moves the next blade battery cell 12 into the testing fixture 18.

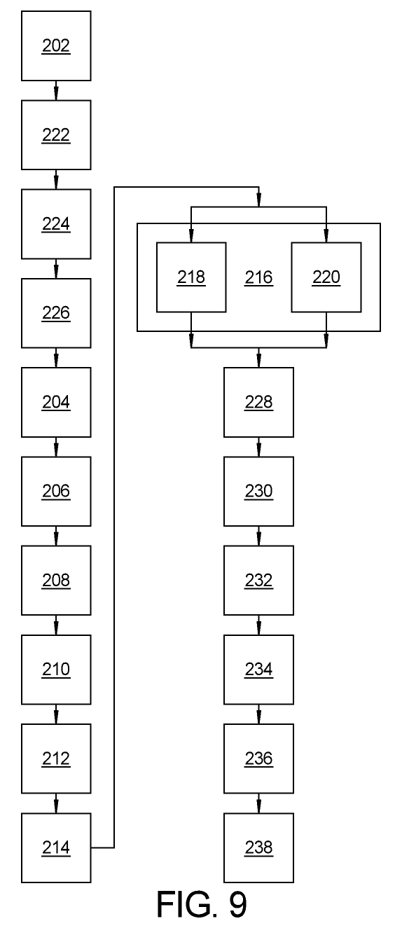

Referring to FIG. 9, a method 200 for leak testing a prismatic blade battery cell 12 includes, with a system 10 having a system controller 14, beginning at block 202, supporting and transporting a blade battery cell 12 to a testing fixture 18 of the system 10, moving to block 204, extending a first vacuum chamber assembly 20 from a retracted position to an extended position, moving to block 206, engaging, with the first vacuum chamber assembly 20, a first distal end 12A of the blade battery cell 12, moving to block 208, extending a second vacuum chamber assembly 26 from a retracted position to an extended position, moving to block 210, engaging, with the second vacuum chamber assembly 26, a second distal end 12B of the blade battery cell 12, moving to block 212, extending a third vacuum chamber assembly 32 from a retracted position to an extended position, moving to block 214, engaging, with the third vacuum chamber assembly 32, a vent plug 36 of the blade battery cell 12, and, moving to block 216, leak testing the blade battery cell 12 by either one of, moving to block 218, leak testing the blade battery cell 12 with a pressurized trace gas before electrolyte is present within the blade battery cell 12, or, moving to block 220, electrolyte leak testing the blade battery cell 12 when electrolyte is present within the blade battery cell 12.

In another exemplary embodiment, the engaging, with the first vacuum chamber assembly 20, a first distal end 12A of the blade battery cell 12 at block 206, further includes moving, with the system controller 14, a horizontally moveable left chamber wall 40A and a horizontally moveable right chamber wall 40B of the first vacuum chamber assembly 20 from a retracted position, toward one another, to an engaged position, wherein the left and right chamber walls 40A, 40B engage side walls 44 of the blade battery cell 12 at the first distal end 12A and clamp the first distal end 12A therebetween, and moving, with the system controller 14, a vertically moveable upper chamber wall 48A and a vertically moveable lower chamber wall 48B of the first vacuum chamber assembly 20 from a retracted position, toward one another, to an engaged position, wherein the upper and lower chamber walls 48A, 48B engage a top surface 52 and a bottom surface 54 of the blade battery cell 12 at the first distal end 12A and clamp the first distal end 12A therebetween, and defining, with the left chamber wall 40A, the right chamber wall 40B, the upper chamber wall 48A and the lower chamber wall 48B of the first vacuum chamber assembly 20, a sealed first vacuum chamber 60 that encapsulates the first distal end 12A of the blade battery cell 12.

In another exemplary embodiment, the engaging, with the second vacuum chamber assembly 26, a second distal end 12B of the blade battery cell 12 at block 210 further includes moving, with the system controller 14, a horizontally moveable left chamber wall 62A and a horizontally moveable right chamber wall 62B of the second vacuum chamber assembly 26 from a retracted position, toward one another, to an engaged position, wherein the left and right chamber walls 62A, 62B engage side walls 44 of the blade battery cell 12 at the second distal end 12B and clamp the second distal end 12B therebetween, and moving, with the system controller 14, a vertically moveable upper chamber wall 68A and a vertically moveable lower chamber wall 68B of the second vacuum chamber assembly 26 from a retracted position, toward one another, to an engaged position, wherein the upper and lower chamber walls 68A, 68B engage a top surface 52 and a bottom surface 54 of the blade battery cell 12 at the second distal end 12B and clamp the second distal end 12B therebetween, and defining, with the left chamber wall 62A, the right chamber wall 62B, the upper chamber wall 68A and the lower chamber wall 68B of the second vacuum chamber assembly 26, a sealed second vacuum chamber 74 that encapsulates the second distal end 12B of the blade battery cell 12.

In another exemplary embodiment, the engaging, with the third vacuum chamber assembly 32, a vent plug 36 of the blade battery cell 12 at block 214 further includes moving, with the system controller 14, a horizontally moveable rear chamber wall 76A and a horizontally moveable front chamber wall 76B of the third vacuum chamber assembly 32 from a retracted position, toward one another, to an engaged position, wherein the rear and front chamber walls 76A, 76B engage the side walls 44 of the blade battery cell 12 between the first and second distal ends 12A, 12B and clamp the blade battery cell 12 therebetween, supporting the blade battery cell 12 with the rear chamber wall 76A of the third vacuum chamber assembly 32, and defining, with the front chamber wall 76B of the third vacuum chamber assembly 32, a sealed third vacuum chamber 82 that encapsulates the vent plug 36 of the blade battery cell 12.

In another exemplary embodiment, the engaging, with the first vacuum chamber assembly 20, a first distal end 12A of the blade battery cell 12 at block 206 further includes, engaging, with an electrolyte nozzle 90 in communication with a trace gas supply module 86, an electrolyte fill port 84 formed within the first distal end 12A of the blade battery cell 12 and adapted to allow electrolyte to be fed into the blade battery cell 12, and the leak testing the blade battery cell 12 with a pressurized trace gas before electrolyte is present within the blade battery cell 12 at block 218 further includes, actuating, with the system controller 14, the trace gas supply module 86 and feeding the pressurized trace gas from the trace gas supply module 86, through the electrolyte port 84, into the blade battery cell 12.

In another exemplary embodiment, the electrolyte leak testing the blade battery cell 12 when electrolyte is present within the blade battery cell 12 at block 220 further includes individually monitoring gases passing through each one of a first test chamber 94 that is positioned between the first vacuum chamber 60 and a vacuum pump 92 in communication with the first, second and third vacuum chambers 60, 74, 82 and adapted to draw gas from each one of the first, second and third vacuum chambers 60, 74, 82, a second test chamber 100 that is positioned between the second vacuum chamber 74 and the vacuum pump 92, wherein gas drawn from the second vacuum chamber 74 passes through the second test chamber 100, and a third test chamber 102 that is positioned between the third vacuum chamber 82 and the vacuum pump 92, wherein gas drawn from the third vacuum chamber 82 passes through the third test chamber 102, and identifying electrolyte leakage from the first distal end 12A, the second distal end 12B and the vent plug 36 of the blade battery cell 12.

In another exemplary embodiment, the individually monitoring gases passing through each one of the first test chamber 94, the second test chamber 100 and the third test chamber 102 at block 220 further includes, applying radiation to the first, second and third test chambers 94, 100, 102 and gases passing through the first, second and third test chambers 94, 100, 102, with a radiation source 108 adapted to produce radiation ranging from about two micrometers to about ten micrometers and positioned behind the first, second and third test chambers 94, 100, 102, and capturing images with an infrared camera 110 having a filter with a bandpass of about seven micrometers to about eight and one-half micrometers and positioned in front of the first, second and third testing chambers 94, 100, 102, wherein the first test chamber 94, the second test chamber 100 and the third test chamber 102 each includes a window 106 that is within a field of view 112 of the infrared camera 110 and is made from sodium chloride glass that is adapted to transmit radiation ranging from about two-hundred-fifty nanometers to about sixteen micrometers.

If testing for CO2 leakage, the bandpass of the filter of the infrared camera 110 should be about four and one-tenth microns to about four and eight-tenths microns. The peak absorption by CO2 occurs at about four and twenty-six hundredths microns. When testing for electrolyte the peak absorption frequency is about five and eight-tenths microns. The presence of vapors from the electrolyte have been detected using a camera with a spectral range of about seven microns to about eight and five-tenths microns.

In another exemplary embodiment, the method includes, at block 202, supporting and transporting, with a plurality of slats 114 of the slatted conveyor 16, a plurality of blade battery cells 12, one blade battery cell 12 positioned on each one of the plurality of slats 114, and, with the system controller 14, prior to leak testing a blade battery cell 12, moving to block 222, reading, using a camera 118 in communication with the system controller 14, a 2D matrix 116 attached to a blade battery cell 12, moving to block 224, writing the information from the 2D matrix 116 onto a radio frequency identification tag 120 on a one of the plurality of slats 114 that is carrying the blade battery cell 12, moving to block 226, advancing, with the slatted conveyor 16, the blade battery cell 12 to the testing fixture 18, and, with the system controller 14, after leak testing the blade battery cell 12, moving to block 228, writing, with a radio frequency identification reader 122, the leak testing results to the radio frequency identification tag 120 on the slat 114, moving to block 230, moving the left chamber wall 40A, 62A and the right chamber wall 40B, 62B of each of the first and second vacuum chamber assemblies 20, 26 from the engaged position to the retracted position, moving to block 232, moving the upper chamber wall 48A, 68A and the lower chamber wall 48B, 68B of each of the first and second vacuum chamber assemblies 20, 26 from the engaged position to the retracted position, moving to block 234, moving the rear chamber wall 76A and the front wall 76B of the third vacuum chamber assembly 32 from the engaged position to the retracted position, moving to block 236, moving the first, second and third vacuum chamber assemblies 20, 26, 32 from the engaged position to the retracted position, and, moving to block 238, advancing the slatted conveyor 16.

The system 10 and method 200 of the present disclosure offers the benefit of providing leak testing of a blade battery cell by leak checking in all susceptible locations simultaneously, ie, the first and second distal ends 12A, 12B and the vent plug 36. The system 10 and method 200 of the present disclosure can be used for two distinct applications. First, for end-of-line (in a cell manufacturing process) or for battery cell check station of incoming cells, where completed blade battery cells can be electrolyte leak tested to see if there are any electrolyte leaks in the blade battery cell, and, second, for checking the welding processes during manufacturing of blade battery cells 12 within a cell manufacturing line (can-to-cap as well as vent cap), where trace gas can be introduced through the electrolyte fill port, and the blade battery cell can be pressure tested prior to the presence of electrolyte therein. Thus, the system and method of the present disclosure can be implemented for two distinctly separate tasks.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for leak testing a prismatic blade battery cell, comprising:
a system controller;
a slatted conveyor adapted to support and transport blade battery cells to a testing fixture;
the testing fixture including:
a first vacuum chamber assembly adapted to selectively extend, from a retracted position to an extended position and engage a first distal end of a blade battery cell;
a second vacuum chamber assembly adapted to selectively extend, from a retracted position to an extended position and engage a second distal end of the blade battery cell;
a third vacuum chamber assembly adapted to selectively extend, from a retracted position to an extended position and engage a vent plug of the blade battery cell;
wherein, upon engagement of the first vacuum chamber with the first distal end, engagement of the second vacuum chamber with the second distal end and engagement of the third vacuum chamber with the vent plug, the system is adapted to leak test the blade battery cell by either one of:
leak testing the blade battery cell with a pressurized trace gas before electrolyte is present within the blade battery cell; or
electrolyte leak testing the blade battery cell when electrolyte is present within the blade battery cell.

2. The system of claim 1, wherein the first vacuum chamber assembly includes:
a horizontally moveable left chamber wall and a horizontally moveable right chamber wall, the left chamber wall and the right chamber wall moveable from a retracted position, toward one another, to an engaged position, wherein the left and right chamber walls engage side walls of the blade battery cell at the first distal end and clamp the first distal end therebetween; and
a vertically moveable upper chamber wall and a vertically moveable lower chamber wall, the upper chamber wall and the lower chamber wall moveable from a retracted position, toward one another, to an engaged position, wherein the upper and lower chamber walls engage a top surface and a bottom surface of the blade battery cell at the first distal end and clamp the first distal end therebetween;
wherein, when the first distal end of the blade battery cell is clamped therein, the left chamber wall, the right chamber wall, the upper chamber wall and the lower chamber wall define a sealed first vacuum chamber that encapsulates the first distal end of the blade battery cell.

3. The system of claim 2, wherein the second vacuum chamber assembly includes:
a horizontally moveable left chamber wall and a horizontally moveable right chamber wall, the left chamber wall and the right chamber wall moveable from a retracted position, toward one another, to an engaged position, wherein the left and right chamber walls engage the side walls of the blade battery cell at the second distal end and clamp the second distal end therebetween; and
a vertically moveable upper chamber wall and a vertically moveable lower chamber wall, the upper chamber wall and the lower chamber wall moveable from a retracted position, toward one another, to an engaged position, wherein the upper and lower chamber walls engage the top surface and the bottom surface of the blade battery cell at the second distal end and clamp the second distal end therebetween;
wherein, when the second distal end of the blade battery cell is clamped therein, the left chamber wall, the right chamber wall, the upper chamber wall and the lower chamber wall define a sealed second vacuum chamber that encapsulates the second distal end of the blade battery cell.

4. The system of claim 3, wherein the third vacuum chamber assembly includes a horizontally moveable rear chamber wall and a horizontally moveable front chamber wall, the rear chamber wall and the front chamber wall moveable from a retracted position, toward one another, to an engaged position, wherein the rear and front chamber walls engage the side walls of the blade battery cell between the first and second distal ends and clamp the blade battery cell therebetween, wherein, when the blade battery cell is clamped therein, the rear chamber wall supports the blade battery cell and the front chamber wall defines a sealed third vacuum chamber that encapsulates the vent plug of the blade battery cell.

5. The system of claim 4, wherein the first distal end of the blade battery cell includes an electrolyte fill port adapted to allow electrolyte to be fed into the blade battery cell and the first vacuum chamber assembly includes an electrolyte nozzle in communication with a trace gas supply module and adapted to engage the electrolyte fill port when the first vacuum chamber assembly engages the first distal end of the blade battery cell;
wherein, when leak testing the blade battery cell with a pressurized trace gas before electrolyte is present within the blade battery cell, the system controller is adapted to actuate the trace gas supply module and feed the pressurized trace gas from the trace gas supply module, through the electrolyte port, into the blade battery cell.

6. The system of claim 4, wherein:
the first, second and third vacuum chambers are in communication with a common vacuum pump adapted to generate a vacuum drawing gas from each of the first, second and third vacuum chambers;
a first test chamber is positioned between the first vacuum chamber and the vacuum pump, wherein gas drawn from the first vacuum chamber passes through the first test chamber;
a second test chamber is positioned between the second vacuum chamber and the vacuum pump, wherein gas drawn from the second vacuum chamber passes through the second test chamber;
a third test chamber is positioned between the third vacuum chamber and the vacuum pump, wherein gas drawn from the third vacuum chamber passes through the third test chamber;
wherein, when electrolyte leak testing the blade battery cell when electrolyte is present within the blade battery cell, the system is adapted to individually monitor gases passing through each one of the first, second and third test chambers to identify electrolyte leakage from the first distal end, the second distal end and the vent plug of the blade battery cell.

7. The system of claim 6, further including:
a radiation source positioned behind the first, second and third test chambers adapted to irradiate the first, second and third test chambers and gases passing through the first, second and third testing chambers;
an infrared camera positioned in front of the first, second and third testing chambers, wherein the first test chamber, the second test chamber and the third test chamber each includes a window that is within a field of view of the infrared camera.

8. The system of claim 7, wherein the radiation source is adapted to produce radiation ranging from about two micrometers to about ten micrometers.

9. The system of claim 7, wherein each of the windows of the first, second and third test chambers is made from sodium chloride glass that is adapted to transmit radiation ranging from about two-hundred-fifty nanometers to about sixteen micrometers.

10. The system of claim 7, wherein:
for monitoring leakage of carbon dioxide trace gas, the infrared camera includes a filter having a bandpass of about four and one-tenth microns to about four and eight-tenths microns; and
for monitoring electrolyte leakage, the infrared camera includes a filter having a bandpass of about seven micrometers to about eight and one-half micrometers.

11. The system of claim 4, wherein the slatted conveyor includes a plurality of slats, each slat adapted to hold and transport a blade battery cell, each blade battery cell including a 2D matrix including information for the blade battery cell;
wherein, the system controller is adapted to:
read, using a camera in communication with the system controller, the 2D matrix, and write the information from the 2D matrix onto a radio frequency identification tag on the slat;
advance, with the conveyor, the blade battery cell to the testing fixture;
move the first, second and third vacuum chamber assemblies from the retracted position to the engaged position;
move the left chamber wall and the right chamber wall of each of the first and second vacuum chamber assemblies from the retracted position to the engaged position;
move the upper chamber wall and the lower chamber wall of each of the first and second vacuum chamber assemblies from the retracted position to the engaged position;
move the rear chamber wall and the front chamber wall of the third vacuum chamber assembly to the engaged position;
leak test the blade battery cell;
write the leak testing results to the radio frequency identification tag on the slat;
move the left chamber wall and the right chamber wall of each of the first and second vacuum chamber assemblies from the engaged position to the retracted position;
move the upper chamber wall and the lower chamber wall of each of the first and second vacuum chamber assemblies from the engaged position to the retracted position;
move the rear chamber wall and the front chamber wall of the third vacuum chamber assembly from the engaged position to the retracted position;
move the first, second and third vacuum chamber assemblies from the engaged position to the retracted position; and
advance the slatted conveyor.

12. A method for leak testing a prismatic blade battery cell, comprising, with a system having a system controller:
supporting and transporting a blade battery cell to a testing fixture of the system;
extending a first vacuum chamber assembly from a retracted position to an extended position;
engaging, with the first vacuum chamber assembly, a first distal end of the blade battery cell;
extending a second vacuum chamber assembly from a retracted position to an extended position;
engaging, with the second vacuum chamber assembly, a second distal end of the blade battery cell;
extending a third vacuum chamber assembly from a retracted position to an extended position;
engaging, with the third vacuum chamber assembly, a vent plug of the blade battery cell; and
leak testing the blade battery cell by either one of:
leak testing the blade battery cell with a pressurized trace gas before electrolyte is present within the blade battery cell; or
electrolyte leak testing the blade battery cell when electrolyte is present within the blade battery cell.

13. The method of claim 12, wherein the engaging, with the first vacuum chamber assembly, a first distal end of the blade battery cell further includes:
moving, with the system controller, a horizontally moveable left chamber wall and a horizontally moveable right chamber wall of the first vacuum chamber assembly from a retracted position, toward one another, to an engaged position, wherein the left and right chamber walls engage side walls of the blade battery cell at the first distal end and clamp the first distal end therebetween; and
moving, with the system controller, a vertically moveable upper chamber wall and a vertically moveable lower chamber wall of the first vacuum chamber assembly from a retracted position, toward one another, to an engaged position, wherein the upper and lower chamber walls engage a top surface and a bottom surface of the blade battery cell at the first distal end and clamp the first distal end therebetween; and
defining, with the left chamber wall, the right chamber wall, the upper chamber wall and the lower chamber wall of the first vacuum chamber assembly, a sealed first vacuum chamber that encapsulates the first distal end of the blade battery cell.

14. The method of claim 13, wherein the engaging, with the second vacuum chamber assembly, a second distal end of the blade battery cell further includes:
moving, with the system controller, a horizontally moveable left chamber wall and a horizontally moveable right chamber wall of the second vacuum chamber assembly from a retracted position, toward one another, to an engaged position, wherein the left and right chamber walls engage side walls of the blade battery cell at the second distal end and clamp the second distal end therebetween; and
moving, with the system controller, a vertically moveable upper chamber wall and a vertically moveable lower chamber wall of the second vacuum chamber assembly from a retracted position, toward one another, to an engaged position, wherein the upper and lower chamber walls engage a top surface and a bottom surface of the blade battery cell at the second distal end and clamp the second distal end therebetween; and
defining, with the left chamber wall, the right chamber wall, the upper chamber wall and the lower chamber wall of the second vacuum chamber assembly, a sealed second vacuum chamber that encapsulates the second distal end of the blade battery cell.

15. The method of claim 14, wherein the engaging, with the third vacuum chamber assembly, a vent plug of the blade battery cell further includes:
moving, with the system controller, a horizontally moveable rear chamber wall and a horizontally moveable front chamber wall of the third vacuum chamber assembly from a retracted position, toward one another, to an engaged position, wherein the rear and front chamber walls engage the side walls of the blade battery cell between the first and second distal ends and clamp the blade battery cell therebetween;
supporting the blade battery cell with the rear chamber wall of the third vacuum chamber assembly; and
defining, with the front chamber wall of the third vacuum chamber assembly, a sealed third vacuum chamber that encapsulates the vent plug of the blade battery cell.

16. The method of claim 15, wherein the engaging, with the first vacuum chamber assembly, a first distal end of the blade battery cell further includes:
engaging, with an electrolyte nozzle in communication with a trace gas supply module, an electrolyte fill port formed within the first distal end of the blade battery cell and adapted to allow electrolyte to be fed into the blade battery cell; and
the leak testing the blade battery cell with a pressurized trace gas before electrolyte is present within the blade battery cell further includes:
actuating, with the system controller, the trace gas supply module and feeding the pressurized trace gas from the trace gas supply module, through the electrolyte port, into the blade battery cell.

17. The method of claim 15, wherein the electrolyte leak testing the blade battery cell when electrolyte is present within the blade battery cell further includes:
individually monitoring gases passing through each one of a first test chamber that is positioned between the first vacuum chamber and a vacuum pump in communication with the first, second and third vacuum chambers and adapted to draw gas from each one of the first, second and third vacuum chambers, a second test chamber that is positioned between the second vacuum chamber and the vacuum pump, wherein gas drawn from the second vacuum chamber passes through the second test chamber, and a third test chamber that is positioned between the third vacuum chamber and the vacuum pump, wherein gas drawn from the third vacuum chamber passes through the third test chamber; and
identifying electrolyte leakage from the first distal end, the second distal end and the vent plug of the blade battery cell.

18. The method of claim 17, wherein the individually monitoring gases passing through each one of the first test chamber, the second test chamber and the third test chamber further includes:
applying radiation to the first, second and third test chambers and gases passing through the first, second and third test chambers, with a radiation source adapted to produce radiation ranging from about two micrometers to about ten micrometers and positioned behind the first, second and third test chambers; and
capturing images with an infrared camera positioned in front of the first, second and third testing chambers, wherein the first test chamber, the second test chamber and the third test chamber each includes a window that is within a field of view of the infrared camera and is made from sodium chloride glass that is adapted to transmit radiation ranging from about two-hundred-fifty nanometers to about sixteen micrometers.

19. The method of claim 15, further including:
supporting and transporting, with a plurality of slats of the slatted conveyor, a plurality of blade battery cells, one blade battery cell positioned on each one of the plurality of slats; and
with the system controller, prior to leak testing a blade battery cell:
reading, using a camera in communication with the system controller, a 2D matrix attached to a blade battery cell;
writing the information from the 2D matrix onto a radio frequency identification tag on a one of the plurality of slats that is carrying the blade battery cell;
advancing, with the slatted conveyor, the blade battery cell to the testing fixture; and
with the system controller, after leak testing the blade battery cell:
writing the leak testing results to the radio frequency identification tag on the slat;
moving the left chamber wall and the right chamber wall of each of the first and second vacuum chamber assemblies from the engaged position to the retracted position;
moving the upper chamber wall and the lower chamber wall of each of the first and second vacuum chamber assemblies from the engaged position to the retracted position;
moving the rear chamber wall and the front chamber wall of the third vacuum chamber assembly from the engaged position to the retracted position;
moving the first, second and third vacuum chamber assemblies from the engaged position to the retracted position; and
advancing the slatted conveyor.

20. A system for leak testing a prismatic blade battery cell, comprising:
a system controller;
a slatted conveyor adapted to support and transport blade battery cells to a testing fixture;
the testing fixture including:
a first vacuum chamber assembly adapted to selectively extend, from a retracted position to an extended position and engage a first distal end of a blade battery cell, and including:
a horizontally moveable left chamber wall and a horizontally moveable right chamber wall, the left chamber wall and the right chamber wall moveable from a retracted position, toward one another, to an engaged position, wherein the left and right chamber walls engage side walls of the blade battery cell at the first distal end and clamp the first distal end therebetween; and
a vertically moveable upper chamber wall and a vertically moveable lower chamber wall, the upper chamber wall and the lower chamber wall moveable from a retracted position, toward one another, to an engaged position, wherein the upper and lower chamber walls engage a top surface and a bottom surface of the blade battery cell at the first distal end and clamp the first distal end therebetween;
wherein, when the first distal end of the blade battery cell is clamped therein, the left chamber wall, the right chamber wall, the upper chamber wall and the lower chamber wall define a sealed first vacuum chamber that encapsulates the first distal end of the blade battery cell;
a second vacuum chamber assembly adapted to selectively extend, from a retracted position to an extended position and engage a second distal end of the blade battery cell and including:
a horizontally moveable left chamber wall and a horizontally moveable right chamber wall, the left chamber wall and the right chamber wall moveable from a retracted position, toward one another, to an engaged position, wherein the left and right chamber walls engage the side walls of the blade battery cell at the second distal end and clamp the second distal end therebetween; and
a vertically moveable upper chamber wall and a vertically moveable lower chamber wall, the upper chamber wall and the lower chamber wall moveable from a retracted position, toward one another, to an engaged position, wherein the upper and lower chamber walls engage the top surface and the bottom surface of the blade battery cell at the second distal end and clamp the second distal end therebetween;
wherein, when the second distal end of the blade battery cell is clamped therein, the left chamber wall, the right chamber wall, the upper chamber wall and the lower chamber wall define a sealed second vacuum chamber that encapsulates the second distal end of the blade battery cell;
a third vacuum chamber assembly adapted to selectively extend, from a retracted position to an extended position and engage a vent plug of the blade battery cell and including:
a horizontally moveable rear chamber wall and a horizontally moveable front chamber wall, the rear chamber wall and the front chamber wall moveable from a retracted position, toward one another, to an engaged position, wherein the rear and front chamber walls engage the side walls of the blade battery cell between the first and second distal ends and clamp the blade battery cell therebetween, wherein, when the blade battery cell is clamped therein, the rear chamber wall supports the blade battery cell and the front chamber wall defines a sealed third vacuum chamber that encapsulates the vent plug of the blade battery cell;
wherein, upon engagement of the first vacuum chamber with the first distal end, engagement of the second vacuum chamber with the second distal end and engagement of the third vacuum chamber with the vent plug, the system is adapted to leak test the blade battery cell by either one of:
leak testing the blade battery cell with a pressurized trace gas before electrolyte is present within the blade battery cell, wherein the first distal end of the blade battery cell includes an electrolyte fill port adapted to allow electrolyte to be fed into the blade battery cell and the first vacuum chamber assembly includes an electrolyte nozzle in communication with a trace gas supply module and adapted to engage the electrolyte fill port, and feed pressurized trace gas from the trace gas supply module, through the electrolyte port and into the blade battery cell when the first vacuum chamber assembly engages the first distal end of the blade battery cell; or
electrolyte leak testing the blade battery cell when electrolyte is present within the blade battery cell, wherein:
the first, second and third vacuum chambers are in communication with a common vacuum pump adapted to generate a vacuum drawing gas from each of the first, second and third vacuum chambers;
a first test chamber is positioned between the first vacuum chamber and the vacuum pump, wherein gas drawn from the first vacuum chamber passes through the first test chamber;
a second test chamber is positioned between the second vacuum chamber and the vacuum pump, wherein gas drawn from the second vacuum chamber passes through the second test chamber;
a third test chamber is positioned between the third vacuum chamber and the vacuum pump, wherein gas drawn from the third vacuum chamber passes through the third test chamber;
wherein, the system is adapted to individually monitor gases passing through each one of the first, second and third test chambers to identify electrolyte leakage from the first distal end, the second distal end and the vent plug of the blade battery cell.
